(19) United States
(12) Patent Application Publication
(10) Pub. No.: US 2026/0191185 A1
(43) Pub. Date: Jul. 9, 2026

(54) BRIDGE ROPE ASSEMBLY

(71) Applicant: Latitude Outdoors, LLC, Grand Rapids, MI (US)

(72) Inventors: Jake Matelic, Royal Oak, MI (US); Kevin Leach, Grand Rapids, MI (US); Alex Chopp, Royal Oak, MI (US)

(21) Appl. No.: 19/436,178

(22) Filed: Dec. 30, 2025

Related U.S. Application Data
(60) Provisional application No. 63/742,160, filed on Jan. 6, 2025.

(51) Int. Cl. A01M 31/02

(52) U.S. Cl. CPC A01M 31/02

(57) ABSTRACT

A bridge rope assembly includes a main body having a sheath and a rope that extends from a first rope end to a second rope end. The rope includes a first extent that extends from the first rope end toward the second rope end, an intermediate extent that extends from the first extent toward the second rope end, and a second extent that extends from the intermediate extent to the second rope end. The rope is arranged such that at least a portion of the first extent of the rope extends within an interior volume of the sheath through a first opening, at least a portion of the second extent of the rope extends within the interior volume of the sheath through the first opening alongside the first extent of the rope, and the intermediate extent of the rope forms a bight outside of the sheath.

### CROSS-REFERENCE TO RELATED APPLICATIONS

This application claims priority to U.S. Provisional Patent Application No. 63/742,160, filed Jan. 6, 2025, entitled BRIDGE ROPE ASSEMBLY, the disclosure of which is hereby incorporated herein by reference in its entirety.

### FIELD OF THE DISCLOSURE

The present disclosure generally relates to a bridge rope assembly for use with a tree saddle. More specifically, the present disclosure relates to a bridge rope assembly that includes a rope that extends within a sheath and that has an intermediate extent that forms a bight.

### BACKGROUND OF THE DISCLOSURE

Tree saddles often utilize bridge ropes.

### SUMMARY OF THE DISCLOSURE

According to a first aspect of the present disclosure, a bridge rope assembly is provided. The bridge rope assembly includes a main body comprising a sheath that extends from a first sheath end to a second sheath end. The sheath defines an interior volume that extends from a first opening at the first sheath end to a second opening at the second sheath end. A rope extends from a first rope end to a second rope end and includes a first extent that extends from the first rope end toward the second rope end, an intermediate extent that extends from the first extent toward the second rope end, and a second extent that extends from the intermediate extent to the second rope end. The rope is arranged such that at least a portion of the first extent of the rope extends within the interior volume of the sheath through the first opening, at least a portion of the second extent of the rope extends within the interior volume of the sheath through the first opening alongside the first extent of the rope, and the intermediate extent of the rope forms a bight outside of the sheath. A portion of the main body in which the first and second extents of the rope extend within the interior volume of the sheath alongside each other is tied into a knot. The knot is positioned along the main body between the intermediate extent of the rope and the first and second rope ends, and the intermediate extent of the rope, the portion of the first extent of the rope that extends between the intermediate extent of the rope and the knot, and the portion of the second extent of the rope that extends between the intermediate extent of the rope and the knot form a bight.

Embodiments of the first aspect of the disclosure can include any one or a combination of the following features:
the first and second rope ends are positioned adjacent to the second sheath end;
the first and second rope ends are positioned within the interior volume of the sheath;
a heat shrink sleeve is disposed about the main body proximate the first and second rope ends;
the main body extends from a first main body end that is formed by the intermediate extent of the rope to a second main body end distal from the first main body end and disposed proximate to at least one of the second sheath end, the first rope end, and the second rope end;
the knot is positioned between the first main body end and the second main body end, nearer to the second main body end than to the first main body end;
in an extended condition of the main body, wherein the main body is held taut between the first and second main body ends of the main body, the distance between the first main body end and the knot is between about 36 inches and about 44 inches;
in the extended condition of the main body, the distance between the first main body end and the knot is between about 39 inches and about 41 inches;
in the extended condition of the main body, the distance between the first main body end and the knot is about 40 inches;
in the extended condition of the main body, the distance between the first main body end and the first sheath end is between about 3 inches and about 6 inches;
in the extended condition of the main body, the distance between the first main body end and the first sheath end is about 6 inches;
in the extended condition of the main body, the distance between the knot and the first sheath end is between about 34 inches and 38 inches;
in the extended condition of the main body, the distance between the knot and the first sheath end is about 34 inches;
in the extended condition of the main body, the distance between the knot and the second main body end is between about 1 inch and about 3 inches;
in the extended condition of the main body, the distance between the knot and the second main body end is about 2 inches;
in the extended condition of the main body, the distance between the first main body end and the second main body end is between about 40 inches and about 46 inches;
in the extended condition of the main body, the distance between the first main body end and the second main body end is between about 42 inches and about 44 inches;
in the extended condition of the main body, the distance between the first main body end and the second main body end is about 44 inches; and
a friction hitch engaged with the main body between the first sheath end and the knot and configured to extend between the main body and a tree saddle.

According to a second aspect of the present disclosure, a tree saddle assembly is provided. The tree saddle assembly includes a tree saddle that has a support panel, a first bridge loop coupled to the support panel, and a second bridge loop coupled to the support panel. The assembly further includes a bridge rope assembly comprising a main body with a sheath that extends from a first sheath end to a second sheath end, the sheath defining an interior volume that extends from a first opening at the first sheath end to a second opening at the second sheath end. A rope extends from a first rope end to a second rope end and includes a first extent that extends from the first rope end toward the second rope end, an intermediate extent that extends from the first extent toward the second rope end, and a second extent that extends from the intermediate extent to the second rope end. The rope is arranged such that at least a portion of the first extent of the rope extends within the interior volume of the sheath through the first opening, at least a portion of the second extent of the rope extends within the interior volume of the sheath through the first opening alongside the first extent of the rope, and the intermediate extent of the rope is disposed outside of the sheath and is engaged with the first bridge loop of the tree saddle. A portion of the main body in which the first and second extents of the rope extend within the interior volume of the sheath alongside each other is tied into a knot. The knot is positioned along the main body between the intermediate extent of the rope and the first and second rope ends. A friction hitch is engaged with the main body between the first sheath end and the knot and engaged with the second bridge loop of the tree saddle. The portion of the first extent of the rope that extends between the first sheath end and the knot extends alongside the portion of the second extent of the rope that extends between the first sheath end and the knot without crossing over the second extent of the rope.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a tree saddle assembly securing a user to a tree, according to one embodiment;

FIG. 2 is a perspective view of a tree saddle assembly, illustrating a tree saddle and a bridge rope assembly engaged with the tree saddle, according to one embodiment; and

FIG. 3 is an elevational view of a main body of a bridge rope assembly that includes a sheath and rope, according to one embodiment, wherein portions of the rope that extend within an interior volume defined by the sheath are illustrated in phantom, and a portion of the rope that extends outside of the sheath is illustrated in solid lines.

The components in the figures are not necessarily to scale, emphasis instead being placed upon illustrating the principles described herein.

### DETAILED DESCRIPTION OF THE PREFERRED EMBODIMENTS

Additional features and advantages of the present disclosure will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the term “about” means that amounts, sizes, formulations, parameters, and other quantities and characteristics are not and need not be exact, but may be approximate and/or larger or smaller, as desired, unless stated otherwise, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point and independently of the other end-point.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

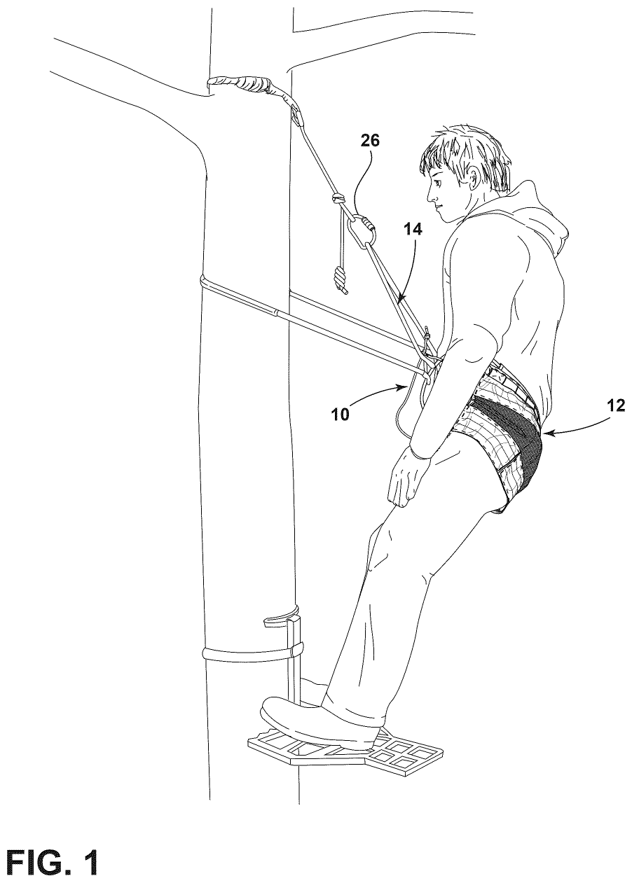

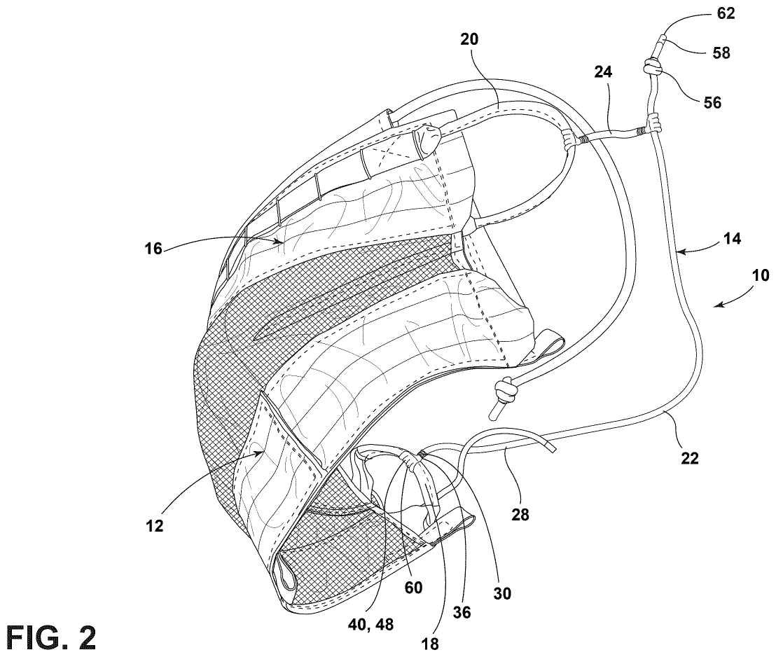

Referring now to FIGS. 1-3, a tree saddle assembly 10 includes a tree saddle 12 and a bridge rope assembly 14. The tree saddle 12 includes a support panel 16. The support panel 16 is configured to cradle a portion of a user of the tree saddle 12 (e.g., legs, buttocks, back). The tree saddle 12 further includes a first bridge loop 18 and a second bridge loop 20. As illustrated in FIG. 2, the first bridge loop 18 is coupled to the support panel 16 proximate to a first end of the support panel 16, and the second bridge loop 20 is coupled to the support panel 16 proximate to a second end of the support panel 16 opposite the first bridge loop 18. The first and second bridge loops 18, 20 are configured to be engaged with the bridge rope assembly 14, as described further herein.

Referring still to FIGS. 1-3, the tree saddle assembly 10 includes the bridge rope assembly 14. The bridge rope assembly 14 is configured to be engaged with the tree saddle 12. In the embodiment illustrated in FIG. 2, a main body 22 of the bridge rope assembly 14 is configured to be engaged with the first bridge loop 18 of the tree saddle 12, and a friction hitch 24 that is engaged with the main body 22 of the bridge rope assembly 14 is configured to be engaged with the second bridge loop 20 of the tree saddle 12. In operation of the tree saddle assembly 10, a rope or strap with an attachment feature 26 (e.g., carabiner) is engaged with a tree, and the main body 22 of the bridge rope assembly 14 extends through the attachment feature 26 for slidable engagement therewith. The tree saddle 12 is engaged with the bridge rope assembly 14 (the first bridge loop 18 with the main body 22 and the second bridge loop 20 with the friction hitch 24 that is engaged with the main body 22), such that the tree saddle 12 is suspended from the tree and operable to support a user occupying the tree saddle 12.

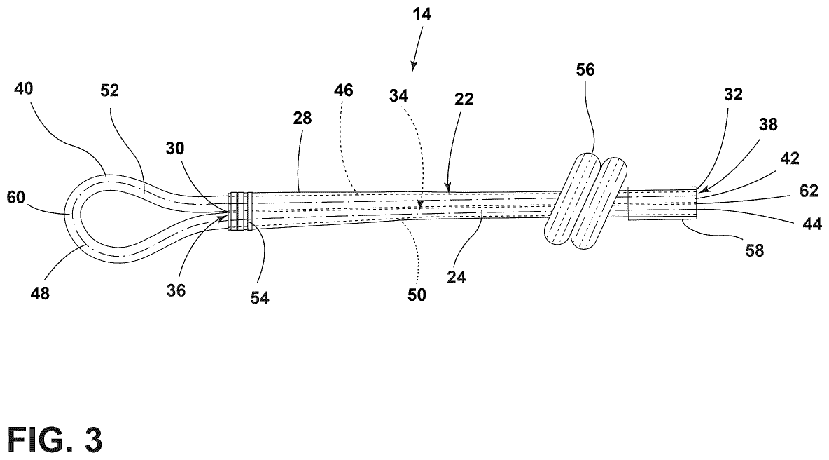

In an exemplary embodiment of the tree saddle assembly 10 illustrated in FIGS. 2 and 3, the tree saddle 12 includes the support panel 16, the first bridge loop 18, and the second bridge loop 20. The bridge rope assembly 14 includes the main body 22. In the exemplary embodiment, the main body 22 includes a sheath 28. The sheath 28 extends from a first sheath end 30 to a second sheath end 32. The sheath 28 defines an interior volume 34 that extends from a first opening 36 at the first sheath end 30 to a second opening 38 at the second sheath end 32. The main body 22 further includes a rope 40. The rope 40 extends from a first rope end 42 to a second rope end 44. The rope 40 includes a first extent 46 that extends from the first rope end 42 toward the second rope end 44, an intermediate extent 48 that extends from the first extent 46 toward the second rope end 44, and a second extent 50 that extends from the intermediate extent 48 to the second rope end 44.

As illustrated in FIG. 3, the rope 40 is arranged such that at least a portion of the first extent 46 of the rope 40 extends within the interior volume 34 of the sheath 28 through the first opening 36, at least a portion of the second extent 50 of the rope 40 extends within the interior volume 34 of the sheath 28 through the first opening 36 alongside the first extent 46 of the rope 40, and the intermediate extent 48 of the rope 40 forms a bight 52 outside of the sheath 28 that is engaged with the first bridge loop 18 of the tree saddle 12. The sheath 28 may be sewn to the rope 40 proximate to the first sheath end 30 after the rope 40 enters the first opening 36, as illustrated exemplarily by the stitching 54 shown in FIG. 3. In some embodiments, the first extent 46 of the rope 40 may be sewn to the second extent 50 of the rope 40 proximate to the first sheath end 30. Sewing the first and second extents 46, 50 of the rope 40 to each other in this manner may aid in ensuring that the bight 52 formed by the rope 40 (rather than a loop) is maintained. As used herein, a “bight” refers to a bend in the rope 40 in which the rope 40 does not cross itself, as illustrated exemplarily in FIG. 3.

As further illustrated in FIG. 3, a portion of the main body 22, in which the first and second extents 46, 50 of the rope 40 extend within the interior volume 34 of the sheath 28 alongside each other, is tied into a knot 56. The knot 56 is positioned along the main body 22 between the intermediate extent 48 of the rope 40 and the first and second rope ends 42, 44. As illustrated in FIG. 3, the intermediate extent 48 of the rope 40, the portion of the first extent 46 of the rope 40 that extends between the intermediate extent 48 of the rope 40 and the knot 56, and the portion of the second extent 50 of the rope 40 that extends between the intermediate extent 48 of the rope 40 and the knot 56 form a bight 52. The bight 52 terminates as the first extent 46 of the rope 40 and the second extent 50 of the rope 40 cross over each other at the knot 56. As further illustrated in FIG. 3, the portion of the first extent 46 of the rope 40 that extends between the first sheath end 30 and the knot 56 extends alongside the portion of the second extent 50 of the rope 40 that extends between the first sheath end 30 and the knot 56 without crossing over the second extent 50 of the rope 40. In various embodiments, the intermediate extent 48 of the rope 40 is disposed outside of the sheath 28 and is configured to be engaged with the first bridge loop 18 of the tree saddle 12. For example, as illustrated in FIG. 2, the intermediate extent 48 is disposed outside of the sheath 28 and is engaged with the first bridge loop 18 of the tree saddle 12.

As illustrated in FIG. 2, in the exemplary embodiment, the friction hitch 24 of the bridge rope assembly 14 is engaged with the main body 22 between the first sheath end 30 and the knot 56 and is engaged with the second bridge loop 20 of the tree saddle 12.

Referring now to FIG. 3, in some embodiments, the first and second rope ends 42, 44 are positioned adjacent to the second sheath end 32. In some embodiments, the first and second rope ends 42, 44 are positioned within the interior volume 34 of the sheath 28. In some implementations, the main body 22 includes a heat shrink sleeve 58. As illustrated in FIG. 2, the heat shrink sleeve 58 is disposed about the main body 22 of the bridge rope assembly 14 proximate to the first and second rope ends 42, 44 and the second sheath end 32.

Referring now to FIGS. 2 and 3, the main body 22 of the bridge rope assembly 14 includes a first main body end 60 and a second main body end 62. The first main body end 60 is formed by the intermediate extent 48 of the rope 40 and the second main body end 62 is distal from the first main body end 60. As illustrated in FIG. 3, the second main body end 62 may be disposed proximate to the heat shrink sleeve 58, the second sheath end 32, the first rope end 42, and/or the second rope end 44. The main body 22 extends along a length of the main body 22 from the first main body end 60 to the second main body end 62. In various implementations, the knot 56 of the main body 22 is positioned between the first main body end 60 and the second main body end 62 nearer to the second main body end 62 than to the first main body end 60.

Referring now to FIG. 3, the main body 22 is operable to enter an extended condition. In the extended condition of the main body 22, the main body 22 is held taut between the first and second main body ends 60, 62 of the main body 22. As illustrated in FIG. 3, the intermediate extent 48 of the rope 40 of the main body 22 forms a gently curving bight 52 for the purpose of illustrating the general shape of the intermediate extent 48; however, it is contemplated that the intermediate extent 48 may be oriented differently (e.g., a relatively sharp fold at the first main body end 60 and generally parallel rope portions 40 extending therefrom toward the first opening 36 of the sheath 28) when the main body 22 is taut in the extended condition.

In some embodiments, in the extended condition of the main body 22, the distance between the first main body end 60 and the second main body end 62 is between about 40 inches and about 46 inches. In some embodiments, in the extended condition of the main body 22, the distance between the first main body end 60 and the second main body end 62 is between about 42 inches and about 44 inches. In some embodiments, in the extended condition of the main body 22, the distance between the first main body end 60 and the second main body end 62 is about 43 inches. In some embodiments, in the extended condition of the main body 22, the distance between the first main body end 60 and the second main body end 62 is about 44 inches.

In some embodiments, in the extended condition of the main body 22, the distance between the first main body end 60 and the knot 56 is between about 36 inches and about 44 inches. In some embodiments, in the extended condition of the main body 22, the distance between the first main body end 60 and the knot 56 is between about 39 inches and about 41 inches. In some embodiments, in the extended condition of the main body 22, the distance between the first main body end 60 and the knot 56 is about 40 inches.

In some embodiments, in the extended condition of the main body 22, the distance between the first main body end 60 and the first sheath end 30 is between about 3 inches and about 6 inches. In some embodiments, in the extended condition of the main body 22, the distance between the first main body end 60 and the first sheath end 30 is about 4.5 inches. In some embodiments, in the extended condition of the main body 22, the distance between the first main body end 60 and the first sheath end 30 is about 6 inches.

In some embodiments, in the extended condition of the main body 22, the distance between the knot 56 and the first sheath end 30 is between about 34 inches and 38 inches. In some embodiments, in the extended condition of the main body 22, the distance between the knot 56 and the first sheath end 30 is about 36 inches. In some embodiments, in the extended condition of the main body 22, the distance between the knot 56 and the first sheath end 30 is about 34 inches.

In some embodiments, in the extended condition of the main body 22, the distance between the knot 56 and the second main body end 62 is between about 1 inch and about 3 inches. In some embodiments, in the extended condition of the main body 22, the distance between the knot 56 and the second main body end 62 is about 1.5 inches. In some embodiments, in the extended condition of the main body 22, the distance between the knot 56 and the second main body end 62 is about 2 inches.

The tree saddle assembly 10 of the present disclosure provides a variety of advantages. First, forming a bight 52 with the portion of the first extent 46 of rope 40 that is between the knot 56 and the intermediate extent 48 of rope 40, the intermediate extent 48 of rope 40, and the portion of the second extent 50 of rope 40 that is between the knot 56 and the intermediate extent 48 of rope 40, and then placing a sheath 28 over the portion of the bight 52 that is engaged by the friction hitch 24 results in a smooth uniform surface along the main body 22 that allows for convenient catch-free sliding of the friction hitch 24 along the main body 22 during use. Second, utilizing the bight 52 within the sheath 28 as referenced above provides a compressible main body 22 that enhances the hold that the friction hitch 24 has on the main body 22 when cinched. Third, utilizing a sheath 28 made of a material, such as nylon rather than relying on a braided polyethylene (e.g., UHMWPE) to directly interface with the friction hitch 24 increases the ease of sliding the friction hitch 24 relative to the main body 22 for the user. Fourth, using a hollow braided rope 40 for the rope 40 of the main body 22 enhances the compressibility of the main body 22 which helps ensure that the friction hitch 24 does not slip when cinched onto the main body 22.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A bridge rope assembly, comprising:
a main body, comprising:
a sheath that extends from a first sheath end to a second sheath end, the sheath defining an interior volume that extends from a first opening at the first sheath end to a second opening at the second sheath end; and
a rope that extends from a first rope end to a second rope end and includes a first extent that extends from the first rope end toward the second rope end, an intermediate extent that extends from the first extent toward the second rope end, and a second extent that extends from the intermediate extent to the second rope end, wherein the rope is arranged such that at least a portion of the first extent of the rope extends within the interior volume of the sheath through the first opening, at least a portion of the second extent of the rope extends within the interior volume of the sheath through the first opening alongside the first extent of the rope, and the intermediate extent of the rope forms a bight outside of the sheath,
wherein a portion of the main body in which the first and second extents of the rope extend within the interior volume of the sheath alongside each other is tied into a knot, the knot is positioned along the main body between the intermediate extent of the rope and the first and second rope ends, and the intermediate extent of the rope, the portion of the first extent of the rope that extends between the intermediate extent of the rope and the knot, and the portion of the second extent of the rope that extends between the intermediate extent of the rope and the knot form a bight.

2. The bridge rope assembly of claim 1, wherein the first and second rope ends are positioned adjacent to the second sheath end.

3. The bridge rope assembly of claim 2, wherein the first and second rope ends are positioned within the interior volume of the sheath.

4. The bridge rope assembly of claim 1, further comprising:
a heat shrink sleeve disposed about the main body proximate the first and second rope ends.

5. The bridge rope assembly of claim 1, wherein the main body extends from a first main body end that is formed by the intermediate extent of the rope to a second main body end distal from the first main body end and disposed proximate to at least one of the second sheath end, the first rope end, and the second rope end.

6. The bridge rope assembly of claim 5, wherein the knot is positioned between the first main body end and the second main body end, nearer to the second main body end than to the first main body end.

7. The bridge rope assembly of claim 6, wherein, in an extended condition of the main body, wherein the main body is held taut between the first and second main body ends of the main body, the distance between the first main body end and the knot is between about 36 inches and about 44 inches.

8. The bridge rope assembly of claim 7, wherein, in the extended condition of the main body, the distance between the first main body end and the knot is between about 39 inches and about 41 inches.

9. The bridge rope assembly of claim 8, wherein, in the extended condition of the main body, the distance between the first main body end and the knot is about 40 inches.

10. The bridge rope assembly of claim 7, wherein, in the extended condition of the main body, the distance between the first main body end and the first sheath end is between about 3 inches and about 6 inches.

11. The bridge rope assembly of claim 7, wherein, in the extended condition of the main body, the distance between the first main body end and the first sheath end is about 6 inches.

12. The bridge rope assembly of claim 10, wherein, in the extended condition of the main body, the distance between the knot and the first sheath end is between about 34 inches and 38 inches.

13. The bridge rope assembly of claim 11, wherein, in the extended condition of the main body, the distance between the knot and the first sheath end is about 34 inches.

14. The bridge rope assembly of claim 12, wherein, in the extended condition of the main body, the distance between the knot and the second main body end is between about 1 inch and about 3 inches.

15. The bridge rope assembly of claim 13, wherein, in the extended condition of the main body, the distance between the knot and the second main body end is about 2 inches.

16. The bridge rope assembly of claim 14, wherein, in the extended condition of the main body, the distance between the first main body end and the second main body end is between about 40 inches and about 46 inches.

17. The bridge rope assembly of claim 16, wherein, in the extended condition of the main body, the distance between the first main body end and the second main body end is between about 42 inches and about 44 inches.

18. The bridge rope assembly of claim 15, wherein, in the extended condition of the main body, the distance between the first main body end and the second main body end is about 44 inches.

19. The bridge rope assembly of claim 1, further comprising:
a friction hitch engaged with the main body between the first sheath end and the knot and configured to extend between the main body and a tree saddle.

20. A tree saddle assembly, comprising:
a tree saddle that includes a support panel, a first bridge loop coupled to the support panel, and a second bridge loop coupled to the support panel; and
a bridge rope assembly, comprising:
a main body, comprising:
a sheath that extends from a first sheath end to a second sheath end, the sheath defining an interior volume that extends from a first opening at the first sheath end to a second opening at the second sheath end; and
a rope that extends from a first rope end to a second rope end and includes a first extent that extends from the first rope end toward the second rope end, an intermediate extent that extends from the first extent toward the second rope end, and a second extent that extends from the intermediate extent to the second rope end, wherein the rope is arranged such that at least a portion of the first extent of the rope extends within the interior volume of the sheath through the first opening, at least a portion of the second extent of the rope extends within the interior volume of the sheath through the first opening alongside the first extent of the rope, and the intermediate extent of the rope is disposed outside of the sheath and is engaged with the first bridge loop of the tree saddle,
wherein a portion of the main body, in which the first and second extents of the rope extend within the interior volume of the sheath alongside each other, is tied into a knot, and the knot is positioned along the main body between the intermediate extent of the rope and the first and second rope ends; and
a friction hitch engaged with the main body between the first sheath end and the knot and engaged with the second bridge loop of the tree saddle, wherein the portion of the first extent of the rope that extends between the first sheath end and the knot extends alongside the portion of the second extent of the rope that extends between the first sheath end and the knot without crossing over the second extent of the rope.
